(19) United States
(12) Patent Application Publication
(10) Pub. No.: US 2005/0246942 A1
(43) Pub. Date: Nov. 10, 2005

(54) Method of extermination utilizing heated air

(76) Inventors: A. Christopher Mueller, Overland Park, KS (US); Clarence W. Fisher III, Des Moines, IA (US)

Correspondence Address: SHOOK, HARDY & BACON LLP, 2555 GRAND BLVD, KANSAS CITY,, MO, 64108, US

(21) Appl. No.: 10/842,013

(22) Filed: May 7, 2004

(51) Int. Cl. A01M 13/00; A01M 19/00; F24D 1/00; A01M 1/00; A01M 1/20; A01M 15/00; F25D 17/04; F25B 49/00

(52) U.S. Cl. 43/124; 237/1 R; 43/127; 43/144

(57) ABSTRACT

A method of exterminating organisms is provided utilizing heated circulating air. First, a determination is made as to which enclosed areas of the building or other structure are to undergo extermination. This step defines an application zone. Next, a desired elevated temperature limit is established for heated air that is to be circulated through the application zone. Heaters are provided in airflow communication with the application zone, and circulation fans are positioned throughout the application zone to move the heated air for proper heat distribution. The heaters utilize an amount of recirculated air already present in the application zone to cut down on the amount of energy needed to raise the air temperature within the application zone towards the desired elevated temperature limit, and to eliminate the need for high CFM airflow heaters to achieve air temperature elevation. The temperature at various nodes within the application zone may be monitored to allow personnel to redirect circulating airflow within the application zone to balance out areas of higher air temperature with areas of lower air temperature. The method takes advantage of convection heat transfer to raise the temperature evenly within an application zone, minimizing temperature stratification which could result in ineffective pest extermination and/or damage to equipment and facilities.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

Conventional methods of organism control—more specifically pest control—within buildings and other structures often involve the use of fumigant pesticides. These methods have proven over time to be effective in exterminating pests such as insects, and inhibiting their ability to repopulate the given structure.

More recently, the use of heated ambient air (or other inert or chemically stable gas) has been employed as an extermination tool. Most organisms cannot survive for an extended length of time over about 120-122° F., and if the atmosphere and structure within a building can be held above that temperature for a period of time, effective pest extermination can be realized. However, current heated air extermination schemes suffer from a number of disadvantages. First, these heated air methods involve the movement of 100% outside air at high cubic feet-per-minute (CFM) rates into facilities to be treated. This is because the ambient air temperature outside the facility is usually substantially below the desired elevated temperature to be achieved within, and thus a large mass of heated air must be moved into the facility to achieve the proper climb in temperature. A significant amount of energy must be expended to achieve this rate with standard heaters and fans or other air moving devices; the high mass flow rate of hot air leaving the heaters also tends to damage heat sensitive items through rapid heat gain, because so much thermal energy is transferred by fast moving heated air exiting the heaters. Another disadvantage of current heated air extermination methods relates to heated air losses. Because with these methods so much heated air is moved into the facility quickly from the outside, over pressurization may result, which can cause damage. Attempts have been made to avoid creating excessive pressures within the facility by exhausting out a significant amount of internal air during the heated air methods. However, the exhausted air not only represents a loss of heated air, and thus wasted energy, but also makes it difficult to properly regulate the temperature across the facility. This leads to cool spots where pest extermination is inhibited and hot spots where facility damage may occur, the very result that was intended to be avoided. Thus, pest control managers continue to be frustrated with current heated air extermination methods that can be performed at a reasonable cost.

### BRIEF SUMMARY OF THE INVENTION

Accordingly, the method of the present invention, and various aspects thereof, provide for improved pest control utilizing recirculated heated air. In this way, an even temperature distribution of both (a) air within an enclosed area of a building or other structure, and (b) across the structure itself, may be achieved while protecting the integrity of the structure and items placed therein.

In one aspect of the method of the present invention, an organism extermination cycle first requires determining which enclosed areas of the structure are to undergo extermination, and thus, define an application zone. A desired elevated temperature limit is then established for heated air that is to be circulated through the application zone. Heaters, in airflow communication with the application zone, and circulation fans, positioned throughout the application zone, generate a flow of heated air that may be directed throughout the facility for proper heat distribution. Advantageously, the heaters utilize an amount of recirculated air already present in the application zone to cut down on the amount of energy needed to raise the air temperature within the application zone towards the desired elevated temperature limit, and to eliminate the need for high CFM heaters to achieve air temperature elevation. Temperature measuring may also be conducted at various locations within the application zone to learn how heated air is being distributed, and to enable technicians to redirect circulating airflow around the application zone to balance out areas of higher air temperature with areas of lower air temperature.

In another aspect of the invention, ducting may be used to direct and disperse heated air from the heaters to locations within the application zone, and also may be attached to recirculation fans to channel cooler air to locations where the air temperature is high relative to other areas, and to channel hotter air to locations where the air temperature is low relative to other areas. For example, ducts may be coupled with recirculation fans to force warmer air form upper levels or floors within a facility to lower levels where the air is cooler, and vice versa.

The present invention is thus a convection-based system relying on the circulation of heated air with, preferably, high CFM fans positioned internally to the application zone, once such heated air has been introduced into an application zone from the heaters. Therefore, internal circulation fans and recirculation fans with ducting are primarily used to move large amounts of air without the need for the heaters to be excessively high CFM flow heaters. These high CFM flow heaters used in the prior art can cause excessive temperature stratification across the application zone and damage to equipment and/or facilities proximal to the point where the heated air enters the structure.

### BRIEF DESCRIPTION OF THE SEVERAL VIEWS OF THE DRAWING

FIG. 1 is schematic diagram of a building showing the introduction of heated air into the building and the recirculation of heated air within the building in accordance with one embodiment of the present invention;

FIG. 2 is a schematic diagram of another building having multiple floors showing recirculated heated air ducted between floors for improved heat distribution;

FIG. 3 is a view of a display showing measured temperature and airflow direction at various nodes across one floor of a building; and

FIG. 4 is a flowchart showing a method of conducting pest extermination in accordance with one embodiment of the present invention.

### DETAILED DESCRIPTION OF THE INVENTION

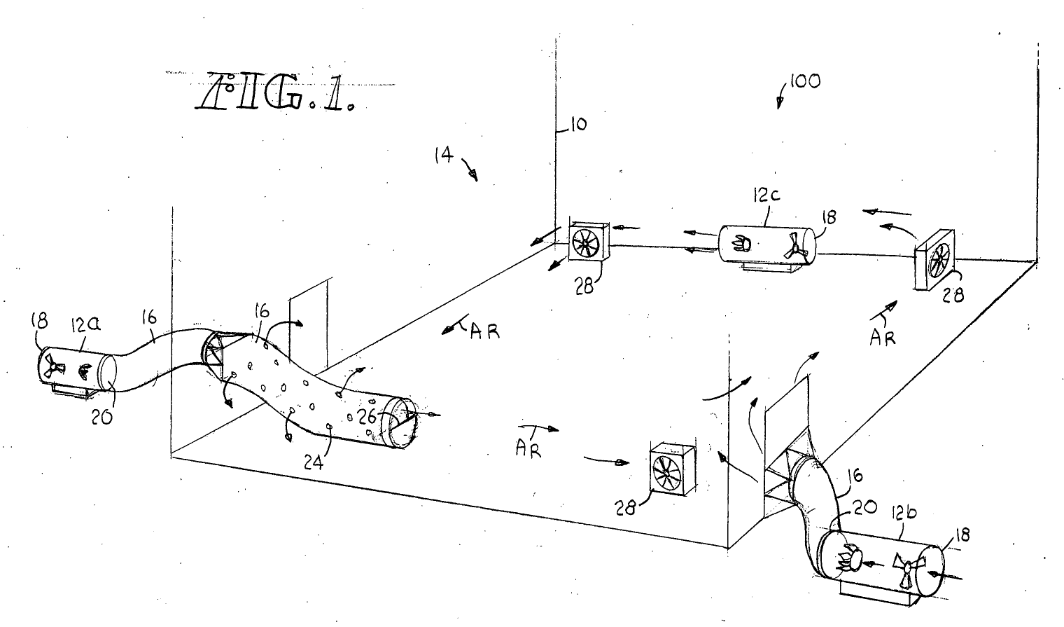

With reference to the several views of the drawing, and in particular FIG. 1, there is shown an enclosure, such as a building 10, where heated recirculated air (indicated by arrows AR) is utilized for pest extermination. Heaters 12a, 12b and 12 are depicted in FIG. 1, and may be referred to generically as heater(s) 12. However, any number of heaters 12 may be used according to calculated thermal energy needs for the building 10 to realize the necessary lethal temperature for pests. Heaters 12a-c may be, for example, direct or indirect gas-fired propane heaters that blow out a certain CFM of air at a certain elevated temperature; alternatively, heaters 12a-c may be any other kind of heater (e.g., natural gas, diesel, electric, steam, etc., or any heat source already available to the facilities operator, such as the HVAC system of the building 10), and may have a blower/fan included with the heater or located near the heater to move an amount of the heated air. One advantage of indirect gas-fired heaters over direct gas-fired versions is that any recirculated air returned for intake into the indirect heater 12 does not contact the flame of the heater, eliminating the risk of the flame igniting any particulate matter or other contaminants in the recirculated air flow. In the exemplary embodiment, heaters 12a and 12b are located external to the building 10, such as in the ambient outdoor environment, and draw in ambient air for heating, and heater 12c is located either within the building 10—to draw in already heated recirculating air moving within an application zone 14 of the building—or external to the building, but intaking air at least partially from within the application zone 14.

Although the building 10 is shown as a single enclosed area forming the application zone 14 for heated air pest extermination, the building may be subdivided into a number of enclosed areas (e.g., rooms, etc.), some or all of which may be considered an application zone 14 to undergo heat treatment depending on the desired regions for pest extermination. Further, it should be understood that the term “structure”, within which pest extermination takes place according to the methods of the present invention, refers to any type of structure that may have enclosed areas or be manipulated to create enclosed areas; examples of which include fixed buildings (e.g., commercial or residential), truck trailers (e.g., an 18-wheeler trailer), shipping or storage containers (e.g., seafaring cargo containers), temporary enclosed areas formed with various materials (e.g., placing tarpaulin sheeting around and above a certain area with a floor or the ground below, such as over a group of pallets on a floor), and the like. The present invention is also particularly well suited for insect extermination, including adults insect, larvae and eggs, but extermination of other organisms may be conducted as those of skill in the art will appreciate.

The heaters 12 bring about an elevation in the air temperature within the application zone 14 to a level necessary to achieve pest extermination therein. Depending on the types of pests located within the application zone 14, the desired air temperature for extermination (the “desired elevated temperature range”) may vary, but preferably for common pests is within a range between about 120° F. to 122° F. on the low end, and about 140° F. on the high end. Most preferably, a target elevated temperature for effective pest extermination is around 130° F.

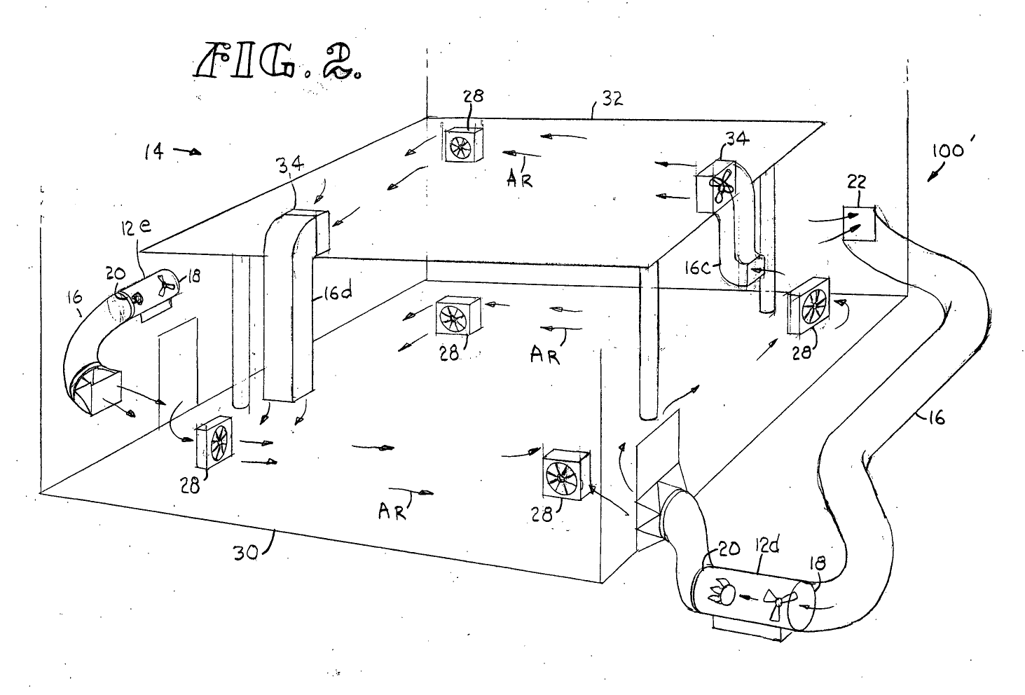

Conduits, or ducts 16, may be fitted to an inlet region 18 and a discharge region 20 of the heaters 12a-c to draw in air from, and exhaust air to, desired regions within or outside of the application zone 14 (i.e., draw in air from the ambient outdoor environment with heaters 12a and 12b, and from within the application zone 14 with heater 12c, and exhaust air inside of the building with all of the heaters 12a-c). In the case of heaters 12a, 12b, the ducts 16 fitted to the respective discharge regions 20 are fitted on an opposing end thereof to a pathway into the building 10, such as a window or door opening, permanent ventilation duct, etc. It should be understood though that the heaters 12a-c may be positioned anywhere relative to the building 10 so long as about 15% or more of the air traveling into the inlet region 18 of the heaters 12a-12c (i.e., drawn into the heaters) is air that has already been present in the respective application zone 14 for a majority of the time period of a heat treatment phase. In other words, the air coming into the heaters 12a-12c should be about 15% or more of air present in the application zone 14 (referred to herein as the “recirculated air percentage”), whether the air directly enters the respective heater inlet region 18 or enters through a duct 16 fitted with the inlet region channeling recirculating heated air to the inlet region 18 from an air exit 22 in the application zone 14, as shown for heater 12d in FIG. 2. The ducts 16 may also be extended beyond the normal point of entry into the building 10 (e.g., window, door, etc.) and well into the application zone 14. As seen in FIG. 1, one duct 16 has a plurality of holes 24 to allow the heated air to disperse into the application zone 14 more gradually to meet specific heated air distribution needs (e.g., if sensitive equipment is located nearby); the duct 16 may also terminate with a baffle 26 to control the flow rate of heated air moved into the application zone 14 at that specific location.

By drawing into the heaters 12a-12c a portion of already heated air from the application zone 14—as opposed to inputting 100% ambient outdoor environment air—the pest extermination methods herein require less energy to heat air discharged into the application zone 14. This is because the temperature of the already heated air component of the airflow into the heater inlet region 18 is typically higher than the outdoor environment air. Although the recirculated air percentage may be as low as about 15% during a majority of the heat treatment phase, it is preferably at least 20%, and may be as high as about 100% for certain types of structures, such as small cubic foot containers. At the initial ramp-up of a heat treatment phase when the average air temperature in the application zone 14 is below the minimum desired air temperature for extermination (e.g., about 120° F. to 122° F.), the 15% or greater recirculated air percentage may not be strictly adhered to over a short time period. However, once the minimum desired air temperature for extermination is reached, the minimum recirculated air percentage of 15% is observed throughout the remainder of the heat treatment phase until a cool-down period is reached where the application zone 14 temperature is intentionally lowered below the minimum desired air temperature.

A plurality of internal circulating fans 28 are preferably strategically positioned throughout the building 10 in the application zone 14. The internal circulating fans 28 move heated air introduced into the building 10 by heaters 12a and 12b, and reheated air generated by heater 12c within the building. For instance, the internal circulating fans 28 may be positioned relative to the discharge region 20 of the heaters 12a-c in a way as to generate a steady flow of heated circulating air in a specified manner around a building floor, such as clockwise or counterclockwise, to promote even heat distribution. In one exemplary arrangement, the internal circulating fans 28 are industrial box fans capable of moving at least about 13,000 CFM of the heated air to generate a moderate to high velocity of air flow during a heat treatment phase for proper convection and control of temperature stratification within the application zone 14.

However, the desired flow rate of the fans 28 is a matter of design choice depending on the requirements for pest extermination in a given facility.

It should be understood that a certain number of internal circulating fans 28 could be incorporated into the housing of the heaters 12 if desired. For example, in situations where additional smaller BTU heaters are positioned internally to the application zone 14 —with larger BTU heaters having their own internal fans located outside the application zone 14—internal circulating fans 28 may be integrated with such small BTU heaters. Collectively, the heaters 12, ducts 16 and internal circulating fans 28 may be referred to as a “system” 100 for conducting heat treatment applications for pest extermination.

Turning now to FIG. 2, there is shown a building 10′ structure similar to that of FIG. 1, but including a first floor 32 and a second floor 34 within the application zone 14. The configuration of the heaters 12d and 12e in FIG. 2 is one example where at least one of the heaters (i.e., heater 12d) receives 100% of the intake air as air that has already been heated (i.e., internally circulated air) so that no outdoor ambient environment air is used. This is realized because heater 12d has both of the inlet region 18 and the discharge region 20 in airflow communication with the application zone 14 through ducts 16a and 16b, respectively. Of course, the combination of heaters 12d and 12e may be configured to accept collectively, for a majority of a heat treatment phase, as low as about 15% of air entering inlet regions 18 of each heater being already heated air.

One particular feature provided in the system 100′ shown in FIG. 2 is the use of the ducts 16 to direct recirculating heated air to different elevations within the application zone 14. For example, as heated air has a tendency to rise, higher floors or open areas within a building 10 will tend to have a higher air temperature (for a given amount of heat output on each floor) due to such convection. Therefore, not only are less heaters 12 typically needed at higher levels of the application zone 14, but it is often desirable to move hotter air at higher vertical points or floors within the zone to lower points or floors, and vice versa. The system 100′, in one exemplary arrangement, includes one duct 16c extending upward from the first floor 30 to the second floor 32 and connected with the intake side of a recirculating fan 34 positioned on the second floor 32, and includes another duct 16d extending downward from the second floor 32 to the first floor 30 and connected with the exhaust side of another recirculating fan 34. This arrangement could obviously be extended through multiple stories (e.g., from a top-level floor to a bottom-level floor) within a building 10, depending on heated air distribution needs to optimize pest extermination. With system 100′, cooler air from the lower building levels (i.e., first floor 30) is drawn up by one recirculation fan 34 through duct 16c to a higher building level (i.e., second floor 32 or higher on the first floor 30) where heated air tends to pool, and warmer air from the higher level is forced down by another recirculation fan 34 through duct 16d to the lower level to create a more even air temperature gradient (i.e., reduced stratification) vertically throughout the application zone 14.

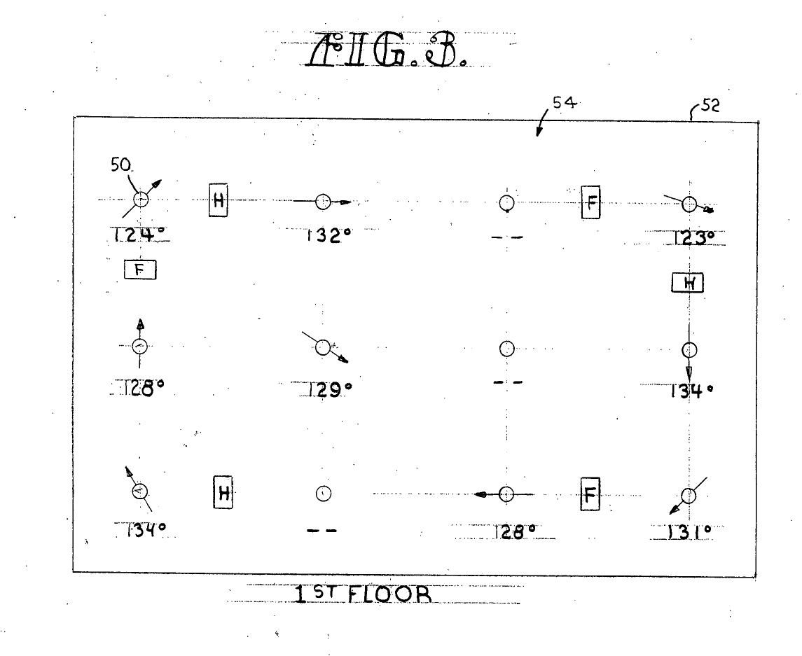

To better optimize heat treatment methods with systems 100, 100′, temperature measurement is utilized at various locations throughout the application zone 14. Locations and/or timing of temperature measurement may be determined while heat treatment is taking place, or may be predetermined before treatment begins to be at an array of nodes 50, as shown in FIG. 3. Temperatures may be measured by any monitoring means, examples of which include using a portable laser infrared temperature sensor aimed at a surface across which heated air is moved (e.g., equipment or the building structure itself, or even an item brought into the application zone 14 during treatment, such as a section of cardboard), using an electronic sensor or other conventional thermometer (e.g., a digital thermometer) where the measured value is read manually. Electronic sensors and conventional thermometers may be fixed in position at the node 50 locations, if desired. In one embodiment, a temperature sensor using radio-frequency (RF) or other communicative means measures a temperature and transmits a signal to a central location regarding the temperature. For example, a display 52 may be provided with a computing device (not shown) to display a map 54 of a given floor (or any portion) of the application zone 14, with the current measured temperature at various nodes 50 displayed for the heat treatment operator. If desired, the map 54 may include the locations of heaters 12 and recirculation fans 28 relative to the nodes 50, as well as airflow directions/speeds measured by any known method (e.g., cup anemometer). Thus, the heat treatment operator may take various steps to optimize heat distribution in the given area, such as: making adjustments to the heat output of the heaters 12; redirecting the heaters 12, internal circulating fans 28, and/or the recirculating fans 34 and ducts 16 to move more air into or away from different regions of the application zone 14; etc. Also, preferably, temperature measurements are made hourly throughout the heat treatment phase, but could be made at various other time intervals if desired.

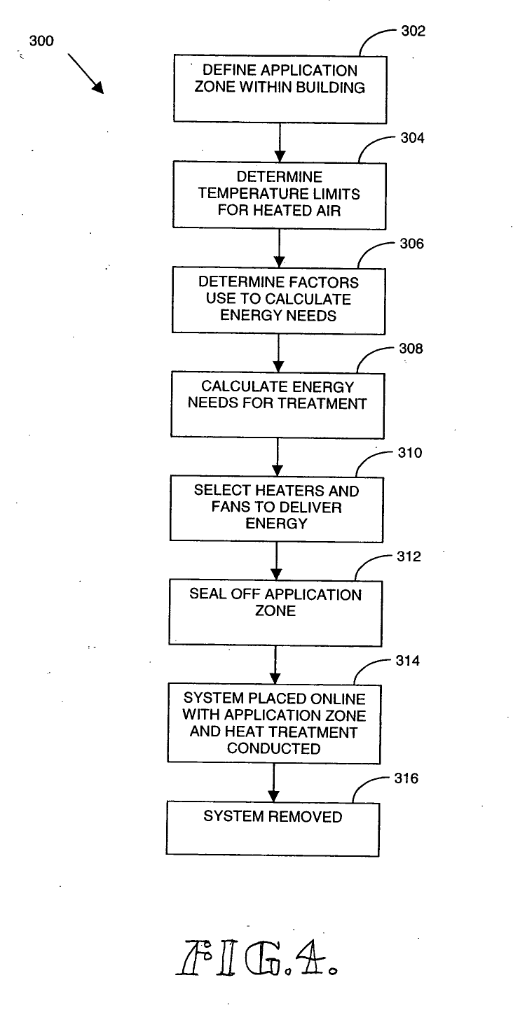

One method 300 of conducting pest extermination with heated air utilizing the systems 100, 100′ of the present invention is shown in FIG. 4. In step 302, a determination is made as to which enclosed areas of a building 10 or other structure are to undergo a pest extermination treatment phase through use of heated air. If the building has multiple rooms and/or floors, some of those areas may not undergo the treatment if, for example, sensitive equipment is located therein and is not easy to remove. The application zone 14 is thus defined as the enclosed areas where treatment is to take place.

A determination is then made, in step 304, as to the desired elevated temperature minimum and maximum, or limit, for the heated air to be circulated through the application zone 14, and the maximum temperature limit for the heated air at the point of introduction into the application zone. The desired elevated temperature limit for heated air is preferably around 140° F. in order to protect the structural components of the building 10 and the contents/equipment stored in the building; however, certain enclosed structures, such as metal shipping containers, may be able to withstand an elevated temperature limit much higher than 140° F. Based on the type of pests desired to be exterminated, the minimum elevated temperature will usually fall within the 120° F.-122° F. range. The heaters 12 are preferably set so that the maximum temperature of the heated air at the point of introduction into the application zone 14 (whether directly from the discharge region 20 or through a duct 16) is no more than 190° F. for an extended period (i.e., a number of hours) during a heat treatment phase, and preferably in the range of 150° F. to 190° F. This ensures that structures within the building 10 proximal to the point of heated air entry into the application zone 14 are not damaged. However, the maximum heated air temperature entering the application zone 14 may be at about 200° F. or a little higher for a short period of time, if heated air with these qualities is needed to accelerate the ramp-up of the average air temperature in application zone 14 during the early stages of a heat treatment phase.

Based on the size of the chosen application zone 14 and the desired elevated temperature range, energy needs for the treatment method may be determined, in step 306. This determination can include a variety of factors, such as: the type of materials used to construct the building, including the square footage of anything exposed to the surrounding outdoor ambient environment; any air pathways/potential leakage spots between the application zone 14 and other areas; the square feet of the application zone;, the equipment and other contents disposed in the application zone (including temperatures that these items can withstand); the difference between the temperature in the surrounding outdoor ambient environment and the desired elevated temperature range; heat transfer coefficient values for the building materials and building contents; the weight of the building contents per square foot; etc.

Based on the determinations of step 306 a calculation is made in step 308 to determine the amount of energy (e.g., BTU's) over the time period of treatment (the treatment phase) needed to effect proper pest extermination. Then, in step 310, heaters 12 and recirculation fans 28 are selected to deliver the energy needs for heat treatment at the necessary flow rate of air. For example, the total amount of CFM's of air at a given temperature produced by a heater 12 is compared to the total cubic feet of the application zone 14 that is to be heated. One suitable ratio that has been found to be effective is to use 1 to 2 high CFM internal circulation fans 28 (e.g., 13,000 CFM fans) per one million of BTU's of heat provided by the heaters 12; however, other ratios may be selected as a matter of design choice to optimize even temperature distribution with the application zone 14. In step 312, the application zone 314 is sealed off from other building 10 areas, for example with plastic sheeting and adhesives to hold it in place, or with more structurally rigid items (e.g., wood panels, etc.).

Subsequently, in step 314, the desired system (e.g., system 100 or system 100′) is put online with the application zone 14 by personnel and the heat treatment phase begins. Preferably, the phase lasts about 14 to 24 hours as measured by the amount of time the average temperature across the application zone 14 (e.g., at nodes 50), or alternatively, all of the temperature readings within the application zone 14, are above the minimum elevated temperature (i.e., 120° F.-122° F.). It is also preferred that the average rise in temperature across the nodes 50 does not exceed 15° F. per hour, and most preferably about 10° F. per hour, once the average temperature measured is at least 100° F., and that the air changes per hour within the application zone is less than about 2.5. The heated air introduced into the treatment zone 14 in the heat treatment phase should be at 190° F. or below for a substantial portion of the phase (e.g., preferably at least 75% of the time of the phase) in order to protect the integrity of the structure forming the application zone 14 and equipment and other items within the application zone 14.

With the method 300 of the present invention, these temperature rise and air change rates within the application zone 14 can be attained with much greater ease that previous methods where 100% outside air is utilized during heat treatment. This is because less heated air is being pushed out of the application zone 14 by the introduction of newly heated air, and the temperature rise within the zone is much more predictable and less dependent on ambient outdoor conditions.

Step 314 of the method 300 can be generally broken down into three areas. The first is a ramp-up phase where the heaters 12, internal circulation fans 28 and, optionally, recirculation fans 34 are first turned on. Temperatures are preferably measured at least hourly to maintain the desired rise rate and to determine when the minimum elevated temperature is attained. The second phase is the treatment or “steady-state” phase, preferably at least 10 hours, and more preferably between about 14 to 24 hours for a large square foot structure. The length of the steady-state phase also allows time for convective heat transfer to occur from the circulating heated air to the equipment or other items within a building, as well as the building itself, to ensure that pests may be exterminated at a variety of locations where they may be harboring within the application zone 14. During the treatment phase, certain heaters 12 may be turned on and off based on the temperatures measured at nodes 50 proximal to the heaters (or at any location within the treatment zone 14, such as the temperature of equipment within the zone), in order to avoid exceeding the desired elevated temperature maximum, and to preferably achieve a targeted air and surface temperature within the zone of around 130° F. To minimize fuel costs, the treatment utilizes as few heaters 12 as are needed to maintain the minimum elevated temperature, and relies on the internal circulating fans 28 and recirculation fans 34 to drive the heated air to areas where temperatures are the coolest, with the temperature measurement at the nodes 50 used to determine whether to redirect the fans 28, 34 to minimize temperature stratification. At some point near the end of the treatment phase, the heaters 12 may be turned off and the internal circulating fans 28 and recirculation fans 34 are used exclusively to continue to move the heated air as the temperature within the application zone is dropping. Finally, the third phase is the cool-down phase, where the fans 28, 34 continued to move the previously heated air present within the application zone. This cool-down phase is entered once the elevated temperature minimum is no longer attained and lasts until the application zone 14 is ready to be used again in its normal operating mode, typically occurring when the average measured temperature in the zone is about 100° F. of less. Preferably, the average drop in temperature through the cool down phase does not exceed about 10° F. per hour in order to reduce stress on the building 10 and contents thereof. Finally, in step 316, the system 100, 100′ is removed

As can be seen, the present invention provides a highly reliable and safe method for pest extermination. Systems 100, 100′ may be made up of generally off-the-shelf components, making installation thereof simple and convenient. It should be further understood that the air used in the methods of the present invention could include other inert or chemically stable gases as opposed to ambient atmospheric air, where the recirculated air percentage is 100%. Since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

1. A method of exterminating organisms within one or more enclosed area of a structure, comprising the steps of:
determining which enclosed areas of the structure are to undergo extermination to define an application zone;
determining a desired elevated temperature limit for heated air circulated through the application zone;
providing one or more heaters in airflow communication with the application zone and having an inlet region and a discharge region;
providing one or more internal circulation fans within the application zone;
heating application air with the one or more heaters, and circulating the application air with the one or more internal circulating fans in the application zone, such that the total amount of the application air traveling into the inlet regions of all of the one or more heaters includes at least a 15% component of air that has already been present in the application zone for at least a majority of a heat treatment phase;
measuring the temperature at a plurality of locations within the application zone;
determining if the measured temperatures have exceeded the desired elevated temperature limit at the plurality of locations within the application zone; and
terminating heating of the application air with the one or more heaters.

2. The method of claim 1, further comprising the step of at least temporarily terminating heating application air with at least one heater of the one or more heaters when the measured temperature at one or more of the plurality of locations has exceeded the desired elevated temperature limit.

3. The method of claim 2, wherein the desired elevated temperature limit is about 140° F.

4. The method of claim 1, wherein the heat treatment phase is defined as the time period during which a measured temperature at one or more of the plurality of locations is maintained above at least about 120° F.

5. The method of claim 4, wherein the heat treatment phase lasts between about 14 hours to about 24 hours.

6. The method of claim 1, wherein the at least one heater provides the application air traveling therethrough with a temperature in the range of about 150° F. to about 190° F. at the location where the application air enters the application zone for at least a majority of the heat treatment phase.

7. The method of claim 1, at least one of the one or more internal circulating fans are each housed with one of the one or more heaters.

8. The method of claim 1, wherein an additional heat supply means is provided within the application zone.

9. The method of claim 1, wherein at least one of the one or more heaters is disposed outside of the application zone and is in airflow communication with the application zone through a conduit connected with the heater to introduce heated application air into the application zone.

10. The method of claim 9, wherein the application zone has an air exit, and wherein at least one heater disposed outside of the application zone has a conduit interconnected the air exit with the inlet region of the respective heater

11. The method of claim 1, wherein the internal circulation fans are high CFM fans, at least some of which are capable of producing an airflow rate of at least about 13,000 CFM.

12. The method of claim 1, wherein the step of heating application air with the one or more heaters, and circulating the application air with the one or more internal circulating fans in the application zone is conducted such that the average temperature rise across the plurality of locations within the application zone where the temperature is measured is no more than about 15° F. per hour.

13. The method of claim 1, wherein the air changes per hour within the application zone are less than about 2.5.

14. The method of claim 1, further comprising the step of sealing off the application zone from other untreated enclosed areas of the structure such that the heated air substantially does not reach the untreated enclosed areas.

15. The method of claim 1, wherein the step of circulating application air with the one or more internal circulating fans in the application zone further includes recirculating the application air by connecting a conduit with one or more recirculating fans such that operation of the one or more recirculating fans will move application air through the conduit to a different elevation within the application zone.

16. The method of claim 15, wherein fan operation will move application air through the conduit to a different floor of the structure within the application zone.

17. The method of claim 1, wherein measuring the temperature at a plurality of locations within the application zone comprises measuring the temperature at a plurality of nodes with temperature monitors.

18. The method of claim 17, further comprising measuring one or more of the airflow direction and airflow speed at the plurality of nodes.

19. The method of claim 1, further comprising, after determining if the measured temperatures have met or exceeded the desired elevated temperature limit, directing the application air from locations of the plurality of locations where the measured temperature has a higher relative value to locations of the plurality of locations where the measure temperature has a lower relative value.

20. The method of claim 1, wherein the step of determining if the measured temperatures have exceeded the desired elevated temperature limit at the plurality of locations within the application zone further comprises determining if the measured temperatures are within the desired elevated temperature range.

21. The method of claim 1, wherein the total amount of the application air traveling into the inlet regions of all of the one or more heaters includes a 15% or more component of air that has already been present in the application zone for at least a majority of a heat treatment phase.

22. The method of claim 1, wherein the structure is a building.

23. The method of claim 1, wherein the structure is a container.

24. The method of claim 1, wherein the structure is a structure formed at least partially with a tarpaulin.

25. A method of exterminating organisms using heated air, comprising the steps of:
determining which enclosed areas of a structure are to undergo extermination to define an application zone;
providing heated air within the application zone at a temperature of 190° F. or less for a substantial portion of a heat treatment phase, the heated air comprising air heated by one or more heaters including at least a 15% component of air that has already been present in the application zone for at least a majority of a heat treatment phase;
internally circulating the heated air throughout the application zone;
measuring the temperature within the application zone; and
upon the measured temperature meeting or exceeding certain requirements, terminating heating of the air with the one or more heaters.

26. The method of claim 25, wherein the step of measuring the temperature comprises measuring the temperature at various locations within the application zone, and wherein the terminating heating of the air with the one or more heaters is realized when the measured temperature at a selected number of the various locations has attained the value of 120° F. for between about 14 to about 24 hours.
